(19) United States
(12) Patent Application Publication
(10) Pub. No.: US 2016/0040634 A1
(43) Pub. Date: Feb. 11, 2016

(54) Vehicle Air Intake Screen Cleaning Device

(71) Applicant: Textron Inc., Providence, RI (US)

(72) Inventors: Stephen William Haight, Charlotte, NC (US); Richard Michael Krzesicki, Charlotte, NC (US)

(21) Appl. No.: 14/456,574

(22) Filed: Aug. 11, 2014

(51) Int. Cl. F02M 35/08; B01D 46/00; B60K 11/08

(52) U.S. Cl. CPC F02M 35/086; B60K 11/085; B01D 46/0075; B01D 46/0058

(57) ABSTRACT

A system is provided for removing debris collected and retained on a radiator air intake screen of a turf-care vehicle hood by an airflow flowing through the air intake screen into a radiator of the turf-care vehicle. In various embodiments, the system comprises an airflow interruption device mountable to the radiator of the turf-care vehicle under the hood of the vehicle. The airflow interruption device is structured and operable to be selectively translatable between an Open position and Closed position to thereby selectively interrupt the airflow flowing through the air intake screen and into the radiator. The system additionally includes a control system comprising an actuator and an actuator controller that are structured and operable to selectively translate the airflow interruption device between the Open and Closed positions.

### FIELD

The present disclosure relates to airflow into an internal combustion engine radiator, and more particularly to systems and methods for cleaning a hood air intake screen of a turf-care vehicle to prevent blockage of airflow into the radiator of the vehicle.

### BACKGROUND

The statements in this section merely provide background information related to the present disclosure and may not constitute prior art.

Commercial turf-care vehicles typically used for cutting, grooming and maintaining grass at golf courses, sporting venues, parks, etc., are generally propelled by an internal combustion engine (ICE) that is water cooled using a radiator cooling system. As is known in the art, such engine cooling systems typically include an engine coolant filled radiator fluidly connected to an engine block of the ICE, and a radiator fan that is operable to draw air through the radiator to cool the engine coolant and hence, the internal combustion engine. The ICEs and radiator cooling systems of such turf-care vehicles are typically disposed under a hood, or engine housing, of the vehicles. Typically, the vehicle hood comprises an air intake screen or grill disposed adjacent the radiator such that air can be drawn through the hood air intake screen and the radiator, via a cooling airflow generated by the radiator fan, in order to cool the engine coolant flowing through the radiator and engine block.

Often during operation of such turf-care vehicles, debris such as grass clippings, leaves, twigs, etc., gets drawn into the cooling airflow and are thereafter retained against the hood air intake screen by the cooling airflow. The debris tends to collect and builds-up on the hood air intake screen and cause blockage or diminishment of the cooling air flow, thereby decreasing the ability of the radiator to efficiently cool the engine coolant. Such a decrease in the cooling efficiency of radiator can cause the ICE to overheat resulting in damage to the ICE. Accordingly, during operation of such turf-care vehicle, the operator of the vehicle has to regularly dismount the vehicle and manually clean the debris off the hood air intake screen to prevent the ICE from overheating.

### SUMMARY

In various embodiments, the present disclosure provides a system for removing debris collected and retained on a radiator air intake screen of a turf-care vehicle hood by an airflow flowing through the air intake screen into a radiator of the turf-care vehicle. In various implementations, the system comprises an airflow interruption device that is mountable to the radiator under the hood of the vehicle. The airflow interruption device is structured and operable to be selectively translatable between an Open position and a Closed position to thereby selectively interrupt the airflow flowing through the air intake screen and into the radiator. The system additionally includes a control system comprising an actuator and an actuator controller that are structured and operable to selectively translate the airflow interruption device between the Open and Closed positions.

In various other embodiments, the present disclosure provides a turf-care vehicle, wherein the vehicle comprises a system for removing debris collected and retained on a radiator air intake screen of a hood of the turf-care vehicle by an airflow flowing through the air intake screen into a radiator of the turf-care vehicle. In various implementations, the system comprises an airflow interruption device that is mountable to the radiator under the hood of the vehicle. The airflow interruption device is structured and operable to be selectively translatable between an Open position and a Closed position to thereby selectively interrupt the airflow flowing through the air intake screen and into the radiator. The system additionally includes a control system comprising an actuator and an actuator controller that are structured and operable to selectively translate the airflow interruption device between the Open and Closed positions.

In yet various other embodiments, the present disclosure provides a method for removing debris collected and retained on a radiator air intake screen of a turf-care vehicle hood by an airflow flowing through the air intake screen into a radiator of the turf-care vehicle. The method comprises selectively translating an airflow interruption device, mountable to the vehicle, between an Open position and a Closed position. The method additionally comprises temporarily interrupting the airflow flowing through the air intake screen into the radiator, as result of translating the airflow interruption device between the Open and Closed positions, such that debris is no longer retained against the air intake screen by the airflow. The method further comprises operating the turf-care vehicle to vibrate the air intake screen such the debris is dislodged from the air intake screen.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an illustration of a turf-care vehicle including a debris removal system, for removing debris collected on a radiator air intake screen of a hood of the turf-care vehicle, in accordance with various embodiments of the present disclosure.

FIG. 2 is an isometric view of an airflow interruption device of the debris removal system shown in FIG. 1, in accordance with various embodiments of the present disclosure.

FIG. 3 is an isometric exploded view of the airflow interruption device shown in FIG. 2, in accordance with various embodiments of the present disclosure.

FIG. 4 is an isometric assembled view of the airflow interruption device shown in FIG. 3, illustrating the airflow interruption device in an Open position, in accordance with various embodiments of the present disclosure.

FIG. 5 is an isometric assembled view of the airflow interruption device shown in FIG. 3, illustrating the airflow interruption device in a Closed position, in accordance with various embodiments of the present disclosure.

FIG. 6 is an isometric view of an airflow interruption device of the debris removal system shown in FIG. 1, in accordance with various other embodiments of the present disclosure, wherein the airflow interruption device is in an Open position.

FIG. 7 is an isometric view of the airflow interruption device of shown in FIG. 6, wherein the airflow interruption device is in a Closed position, in accordance with various other embodiments of the present disclosure.

FIG. 8 is an isometric view of an airflow interruption device of the debris removal system shown in FIG. 1, in accordance with yet various other embodiments of the present disclosure, wherein the airflow interruption device is in an Open position.

FIG. 9 is an isometric view of the airflow interruption device of shown in FIG. 8, wherein the airflow interruption device is in a Closed position, in accordance with various other embodiments of the present disclosure.

FIG. 10 is an isometric view of an airflow interruption device of the debris removal system shown in FIG. 1, in accordance with still yet various other embodiments of the present disclosure, wherein the airflow interruption device is in an Open position.

FIG. 11 is an isometric view of the airflow interruption device of shown in FIG. 10, wherein the airflow interruption device is in a Closed position, in accordance with various other embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

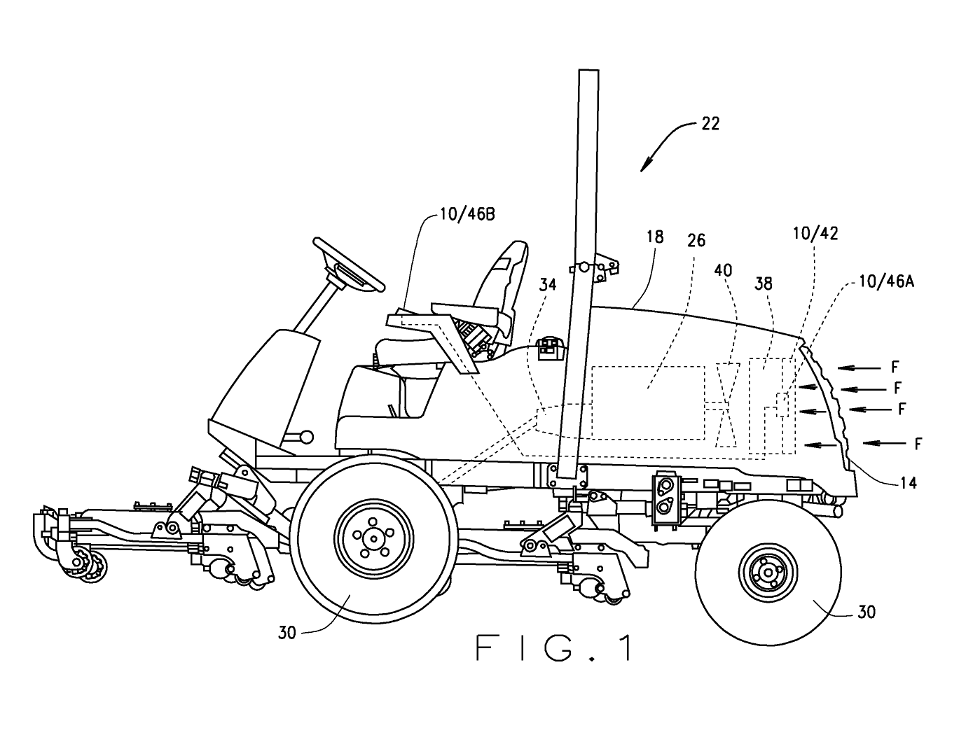

FIG. 1 illustrates a debris removal system 10 for removing debris collected on a radiator air intake screen 14 of an engine hood 18 of a turf-care vehicle 22, in accordance with various embodiments of the present disclosure. It should be understood that the engine hood 18 can be referred to by various other names or terms such as an engine housing, an engine shroud, an engine cover, a rear body of the vehicle 22, etc., and remain within the scope of the present disclosure.

The vehicle 22 generally includes an engine 26, e.g., an internal combustion engine, (or, alternatively an electric motor), that provides motive force to one or more wheels 30, via a drivetrain 34. The motive force is utilized to propel the vehicle 22 across a ground surface, e.g., golf course greens, collars, tee-boxes, approaches, fairways, etc., for cutting the grass of the respective ground surface. The vehicle 10 additionally includes an engine cooling system disposed under the hood 18 that comprises a coolant filled radiator 38 fluidly connected to an engine block of the engine 26, and a radiator fan 40 that is operable to draw air from an exterior environment, i.e., an environment exterior to the hood 18, through the radiator 38 to cool the engine coolant flowing therethrough and hence, cool the engine 26. More specifically, the radiator fan 40 is operable to generate a cooling airflow F that flows from the exterior environment, through the air intake screen 14, and then through the radiator 38 to cool the engine coolant and engine 26. As air is drawn through the air intake screen 14, via the radiator fan 40, debris such as grass clippings, leaves, twigs, etc., can get drawn into the cooling airflow F and thereafter be retained against the hood air intake screen 14 by the cooling airflow F.

The debris removal system 10 is structured and operable to remove such debris from the air intake screen 14 at any selected interval or frequency, as described further below. More particularly, the debris removal system 10 is structured and operable to temporarily interrupt, i.e., substantially cease, the cooling airflow F through the air intake screen 14 such that the debris is released from the air intake screen 14, i.e., the debris is no longer retained against the hood air intake screen 14 by the cooling airflow F, whereafter the debris can become dislodged and fall off the air intake screen via gravity. Additionally, vibrations of the hood 18 and particularly, the air intake screen 14, generated during operation of the vehicle 22, e.g., vibrations caused by operation of the engine 26 and/or by movement of the vehicle 22 across the ground surface, can assist in dislodging the debris from the air intake screen 14 while the airflow F is being interrupted by the debris removal system 10.

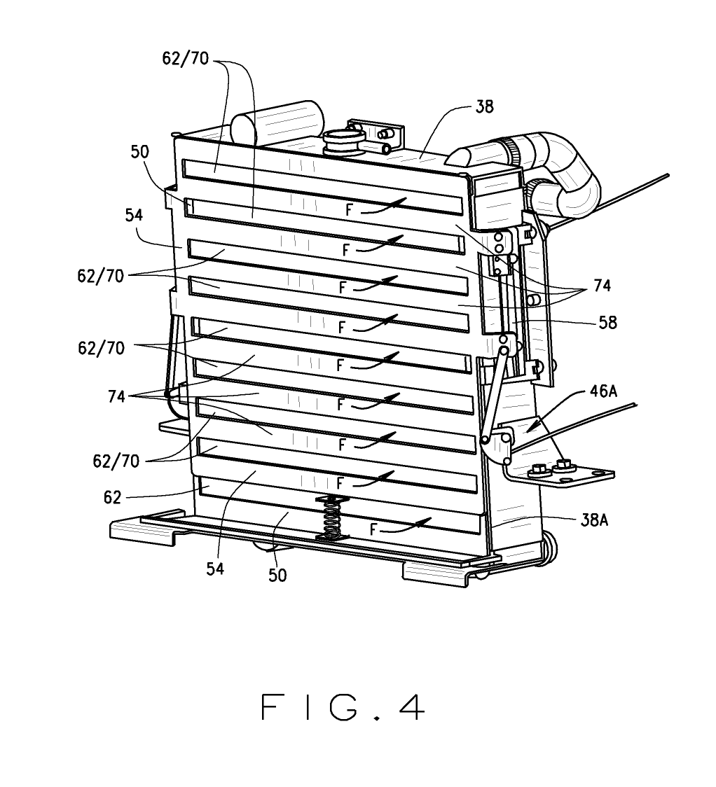

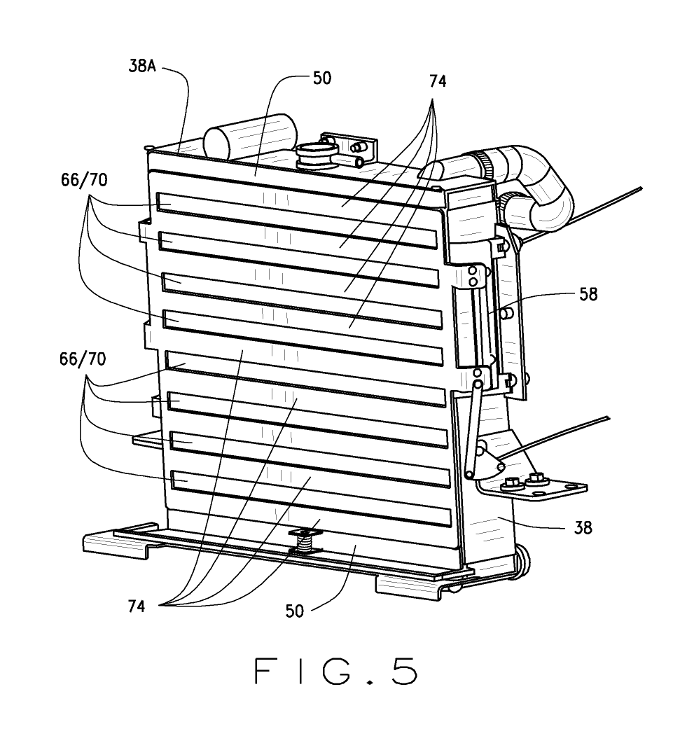

The debris removal system 10 generally comprises an airflow interruption device 42 mountable the radiator 38 adjacent and in close proximity to, or in contact with, an air intake face 38A of the radiator 38 (i.e., adjacent the face of the radiator 38 nearest the air intake screen 14), and an airflow interruption device control system 46. The airflow interruption device 42 is disposed under the hood 18 and is structured and operable to be selectively translatable between an Open position (shown in FIG. 4) and Closed position (shown in FIG. 5) to selectively interrupt the airflow F flowing through the air intake screen 14 and into the radiator 38, as described below. The control system 46 comprises an actuator 46A and an actuator controller 46B that are structured and operable to selectively translate the airflow interruption device 42 between the Open and Closed positions.

In various embodiments, the control system 46 can be electronic, such that translation of the airflow interruption device 14 between the Open and Closed positions is electronically implemented and controlled. For example, in various implementations an operator of the vehicle can manipulate a switch or button of the actuator controller 46B, located in an operator cabin/area of the vehicle 22, at desired intervals to Open and Close the airflow interruption device 42. Particularly, the operator can manipulate the switch or button at desired intervals, whereafter the actuator controller 46B would control operation of the actuator 46A, via a wired or wireless connection between the actuator 46A and the actuator controller 46B, such that the actuator 46A would operate to translate the airflow interruption device 42 between the Open and Closed position to temporarily interrupt the airflow F for a desired duration and allow any debris collected on the air intake screen 14 to fall off, thereby cleaning the air intake screen 14. Subsequently, the actuator controller 46B would either control operation of the actuator 46A to translate the airflow interruption device 42 from the Closed position back to the Open position, or allow the airflow interruption device 42 to automatically return to the Open position, via an auto-return device, such as a spring or other biasing device suitable for biasing the airflow interruption device 42 to the Open position.

In various other implementations, the actuator controller 46A can be a computer based device comprising a processor and electronic memory, and/or integrated circuitry (e.g., an ASIC chip/device), whereby the actuator controller 46B can be programmed to automatically control operation of the actuator 46A to translate the air interruption device between the Open and Closed device at selected intervals and for selected durations, without input from the operator (other than perhaps to turn the actuator controller 46B on and off).

The actuator 46A can be any device suitable for translating the airflow interruption device 42 between the Open and Closed positions, for example, a solenoid, an electric motor, a pneumatic or hydraulic piston, etc.

Alternatively, in various other embodiments, the control system 46 can be mechanical, such that translation of the airflow interruption device 14 between the Open and Closed positions is mechanically implemented and controlled by the vehicle operator during operation of the vehicle 22. In such embodiments, the actuator controller 46B can be a hand or foot operated lever or pedal, located within the operator cabin/area, that is mechanically connected to the actuator 46A via a cable, wire or other suitable linkage. Further, in such embodiments, the actuator 46A can comprise a cam connected to the actuator controller 46B via the cable, wire or other suitable linkage, and a linkage arm connected to the cam and the airflow interruption device 42. The cam and linkage arm are operable, via manual manipulation of the actuator controller 46B by the vehicle operator, to translate the airflow interruption device 42 between the Open and Closed positions, at selected intervals and for selected durations, to temporarily interrupt the airflow F and allow any debris collected on the air intake screen 14 to fall off, thereby cleaning the air intake screen 14. Alternatively, the actuator 46A can be any other mechanical mechanism connected to the actuator controller 46B via the cable, wire or other suitable linkage, and suitable to translated the airflow interruption device between the Open and Closed positions.

As noted above, the airflow interruption device 42 can be maintained in the Closed position for any selected or desired duration, e.g., 1-10 seconds, whereafter the airflow interruption device 42 is returned to the Open position via the actuator 46A and actuator controller 46B, or the auto-return device, such that the airflow F will again be generated by the radiator fan 40. As also noted above, the airflow interruption device 42 can be translated from the Open position to the Closed position to clean/clear the air intake screen 14 at any selected or desired interval, e.g., every 15 to 30 minutes.

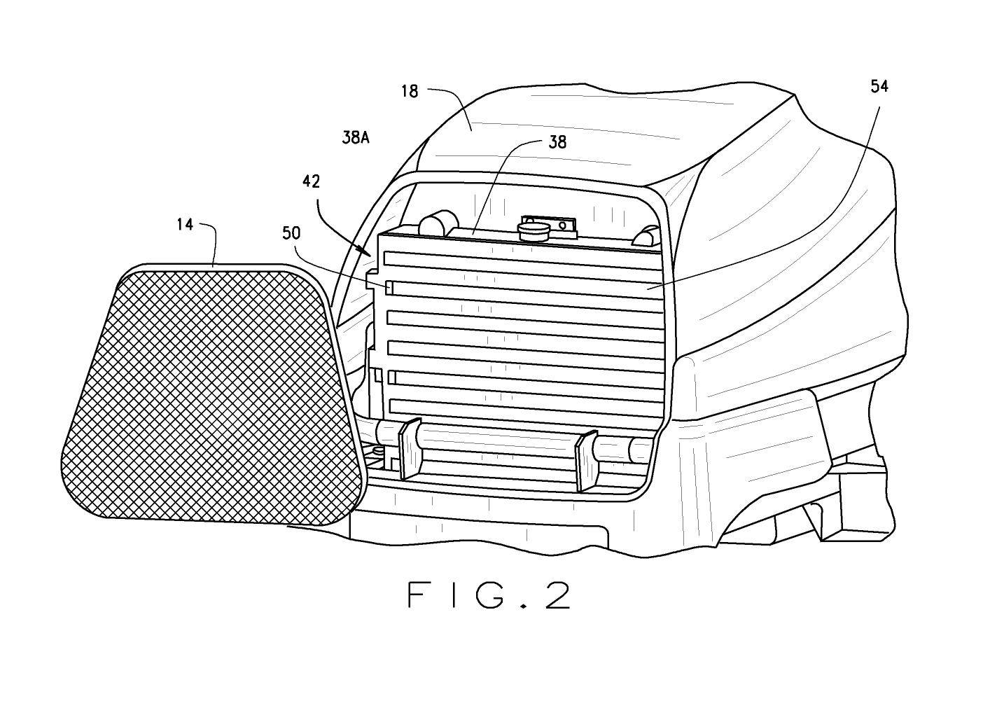

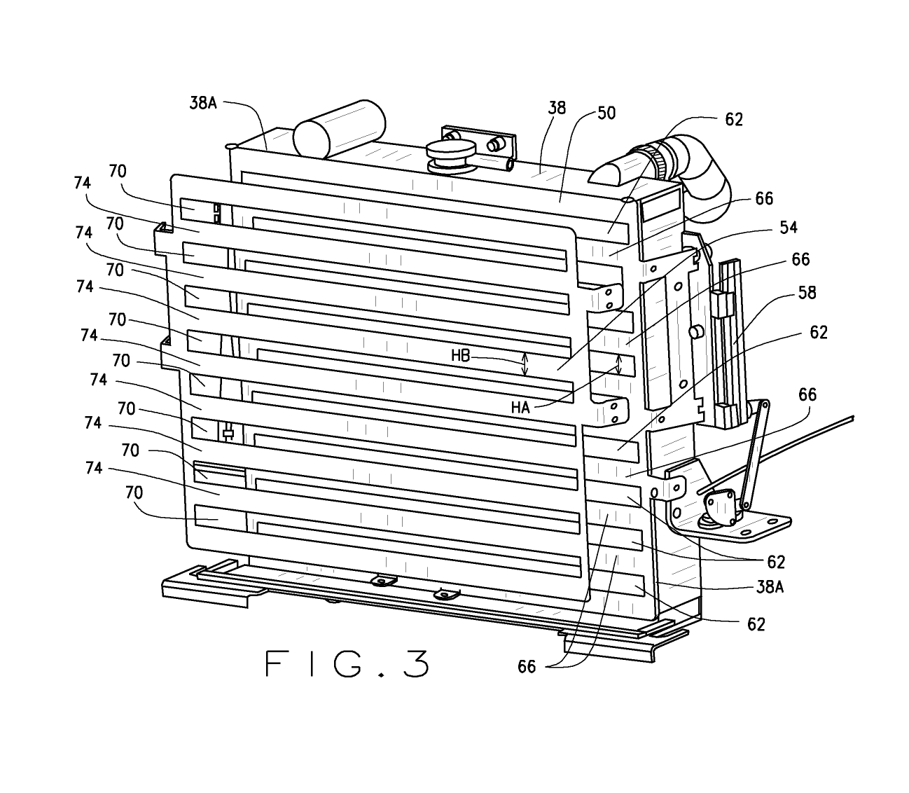

Referring now to FIGS. 2, 3, 4 and 5, in various embodiments, the airflow interruption device 42 comprises a polarizing panel device that includes a first vented panel 50 fixedly mounted to the radiator 38 adjacent and in close proximity to (e.g., 0.10-0.25 inches), or in contact with, the air intake face 38A of the radiator 38, and a second vented panel slideably mounted to the radiator 38 via a slide mechanism 58. The second vented panel 54 is slidably translatable relative to the first vented panel 50 between a first position (shown in FIG. 4) that corresponds to the Open position of the airflow interruption device 42, and a second position (shown in FIG. 5) that corresponds to the Closed position of the airflow interruption device 42, as described further below.

More specifically, the first vented panel 50 includes a plurality of first vent apertures 62 extending therethrough and a plurality of first baffles formed between the first vent apertures 62. Similarly, the second vented panel 54 includes a plurality of second vent apertures 70 extending therethrough and a plurality of second baffles 74 formed between the second vent apertures 70. The second vented panel 54 includes the same number of second baffles 74 as the first vented panel 50 includes vented apertures 62. Moreover, the first and second vent apertures 62 and 70 have substantially the same shape and size, and similarly, the first and second baffles 66 and 74 have substantially the same shape and size. Importantly, the second baffles 74 have a height HB that is substantially equal to a height HA of the first vent apertures 62.

As described above, the second vented panel 54 is selectively slidably translatable relative to the first vented panel 50, via operation of the control system 46 (i.e., via operation of the actuator 46A and actuator controller 46B) between the first position that corresponds to the Open position and the second position that corresponds to the Closed position. Importantly, as illustrated in FIG. 4, when in the Open position the first and second vent apertures 62 and 70 align such that the radiator fan 40 can generate the airflow F that is drawn from the exterior environment through the air intake screen 14, through the aligned first and second vent apertures 62 and 70 and through the radiator 38 to cool the engine coolant flowing through the radiator 38 and hence cool the engine 26. Equally important, as illustrated in FIG. 5, when in the Closed position, the first baffles 66 align with and cover the second vent apertures 70, and the second baffles 74 align with and cover the first vent apertures 62 such that the airflow F is interrupted and no longer able to be generated by the radiator fan 40. Therefore, during the time interval that the air flow interruption device is in the Closed position, e.g., when the second vented panel is in the second position wherein the first and second vent apertures 62 and 70 are covered by the respective second and first baffles 74 and 66, the airflow F is blocked from flowing, and thereby ceased and no longer present to hold any debris on the air intake screen. Accordingly, the debris will fall to the ground via gravity and the vibration of the air intake screen 14 cause by operation of the vehicle 22, thereby clearing, or cleaning, the air intake screen 14 of such debris. Subsequently, the second vented panel 54 will be returned to the first position to place the airflow interruption device 42 back into the Open position such that the airflow F can again be generated.

In various embodiments, the polarizing panel airflow interruption device 42 can include a failsafe return-to-open biasing device 76 that is structured and operable to automatically bias the second vented panel 54 to the Open position. Therefore, if the actuator 46A and/or the actuator controller 46B should fail, the failsafe return-to-open biasing device 76 would automatically bias and translate the second vented panel 54 to the Open position, thereby allowing the airflow F to be generated and preventing overheating of the engine 26. The failsafe return-to-open biasing device 76 can be and device suitable to move the second vented panel 54 to the Open position if the actuator 46A and/or the actuator controller 46B fail(s). For example, the failsafe return-to-open biasing device 76 can be a compression spring, a solenoid, a pneumatic piston, or any other suitable biasing mechanism.

Although the polarizing panel embodiment of the airflow interruption device 42 has been described and illustrated such that the first and second vented panels 50 and 54 have horizontal vent apertures 62/70 and baffles 66/74, and the second vented panel 54 is translated relative to the first vented panel 50 in the vertical direction, this should not be considered to limit the scope of the present disclosure. It is envisioned that the first and second vented panels 50 and 54 can include vertically disposed vent apertures 62/70 and baffles 66/74, and the second vented panel 54 can be translated relative to the first vented panel 50 in the horizontal direction and remain with the scope of the present disclosure.

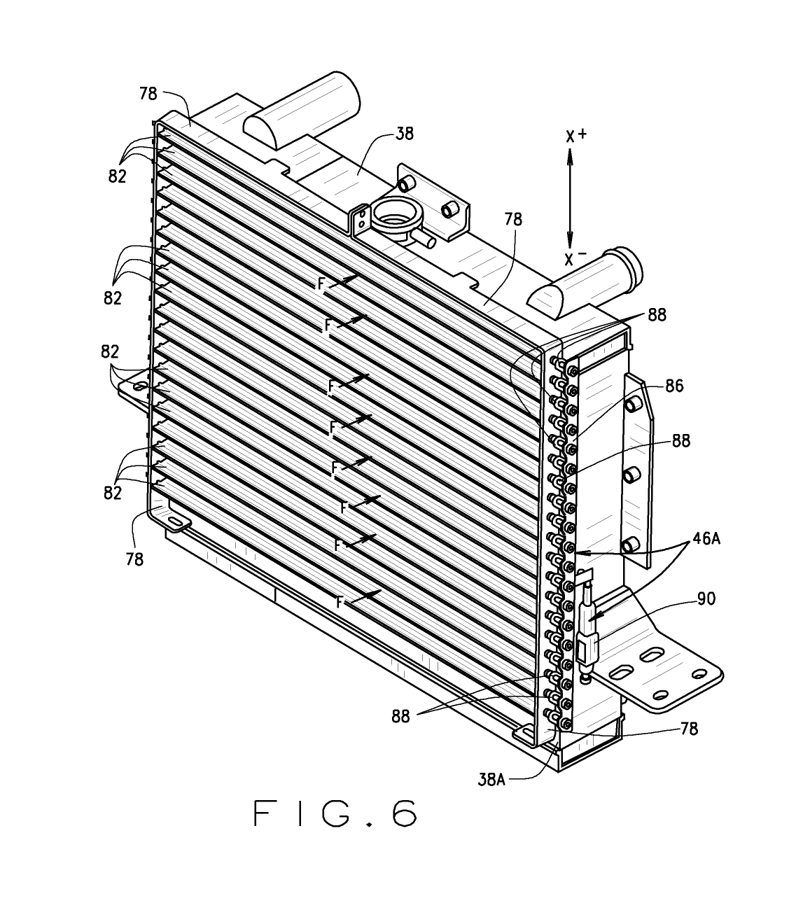

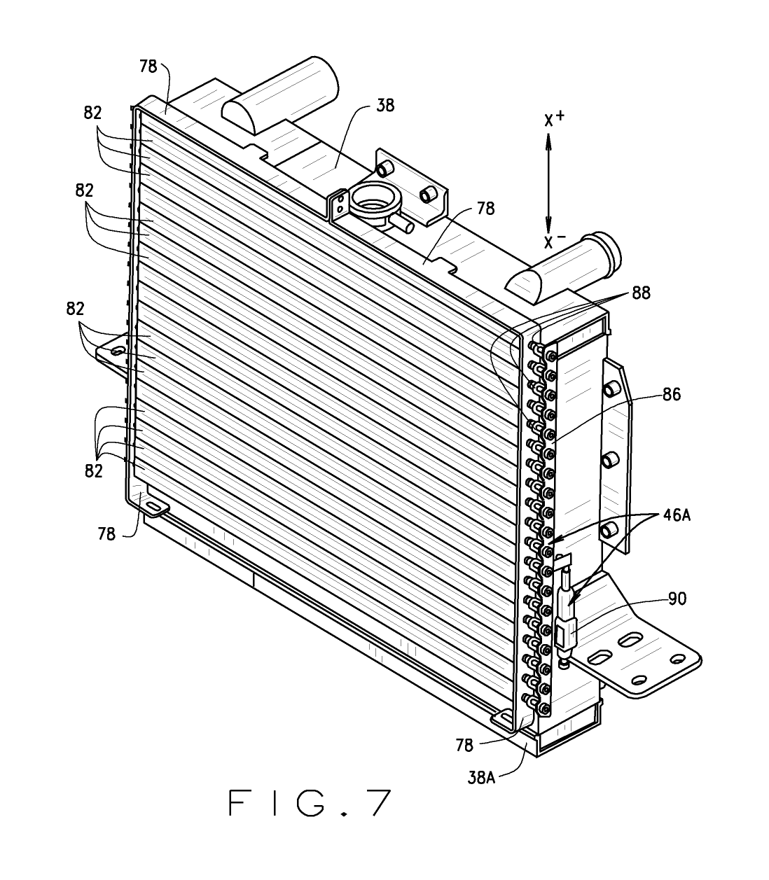

Referring now to FIGS. 6 and 7, in various embodiments, the airflow interruption device 42 comprises a louver panel device that includes a louver frame 78 and a plurality of louver slats 82 pivotally mounted within the frame 78. The louver frame 78 is fixedly mounted to the radiator 38 such that the louver slates 82 are disposed adjacent the radiator air intake face 38A, and in close proximity (e.g., 0.10-0.25 inches) to the radiator air intake face 38A when the louver slats 82 are in the Closed position. As controlled by the control system 46 (i.e., the actuator 46A and actuator controller 46B), the louver slats 82 are selectively pivotally translatable between the Open position (shown in FIG. 6) and the Closed position (shown in FIG. 7). Importantly, as illustrated in FIG. 6, when in the Open position the louver slats 82 are pivoted to provide open spaces between adjacent louvers 82 through which the airflow F can pass. For example, the louver slats 82 can be pivoted such that the louver slats 82 are oriented at an angle between approximately 45° and 90° relative to the air intake face 38A of radiator 38. Accordingly, when the louver slats 82 are placed in the Open position the radiator fan 40 can generate the airflow F that is drawn from the exterior environment through the air intake screen 14, through the open spaces between the louver slats 82, and through the radiator 38 to cool the engine coolant flowing therethrough and hence cool the engine 26.

Equally important, as illustrated in FIG. 7, when in the Closed position, the louver slats 82 are pivoted to an orientation wherein the louver slats 82 are substantially parallel to, and in close proximity (e.g., 0.10-0.25 inches) the air intake face 38A, e.g., the louvers 82 are pivoted to an angle between 170°-180° relative to the air intake face 38A of radiator 38. Particularly, when in the Closed position, a bottom edge of each louver 82 contacts, overlaps or is in very close proximity to (e.g., 0.05-0.20 inches) a top edge of the next lower louver slat 82. Therefore, during the time interval that the air flow interruption device 42 is in the Closed position, e.g., when the louver slats 82 are pivoted to be substantially parallel to the air intake face 38A, the airflow F is blocked from flowing, and thereby ceased and no longer present to hold any debris on the air intake screen. Accordingly, the debris will fall to the ground via gravity and the vibration of the air intake screen 14 cause by operation of the vehicle 22, thereby clearing, or cleaning, the air intake screen 14 of such debris. Subsequently, the louver slats are pivoted and returned the Open position such that the airflow F can again be generated.

In such embodiments, the actuator 46A can comprise any device, mechanism or system suitable to selectively pivot the louver slats 82 between the Open and Closed position, as controlled by the actuator controller 46B. For example, as exemplarily illustrated in FIGS. 6 and 7, in various embodiments the actuator 46A can comprise a louver linking rod 86 having a plurality crank arms 88 pivotally connected thereto and a louver solenoid 90. Each crank arm 88 is pivotally connected at a first end to the linking rod 86 and fixedly connected at an opposing second end to a louver pivot pin extending from an end of a respective one of the louver slats 82. The louver pivot pins are structured and operable to pivotally connect each respective louver slat 82 to the louver frame 78. The louver solenoid 90 is operably connected to the linking rod 86 and is structured and operable to move the linking rod 86 in the X⁺ and X⁻ directions in order to pivot the louver slats 82 between the Closed and Open positions. Particularly, due to the interconnection of all the louver slats 82 to the linking rod 86 via the crank arms 88, as the louver solenoid 90, controlled by the actuator controller 46B, selectively moves the linking rod 86 in the X⁺ and X⁻ directions, the crank arms 88 simultaneously pivot the louver slats 82 between the Closed and Open positions.

Although FIGS. 6 and 7 exemplarily illustrate movement of the linking rod in the X⁻ direction to move the louver slates to the Open position, and illustrates movement of the linking rod in the X⁺ direction to move the louver slates to the Closed position, this should not be considered to limit the scope of the present disclosure. It is envisioned movement of the linking rod in the X⁺ direction can move the louver slates to the Open position, and movement of the linking rod in the X⁻ direction to move the louver slates to the Closed position and remain within the scope of the present disclosure. Additionally, as used herein, the terms top, bottom, upper, lower, up and down are used in reference to the orientation and disposition of the radiator 38 and louver slats 82 as presented in FIGS. 6 and 7.

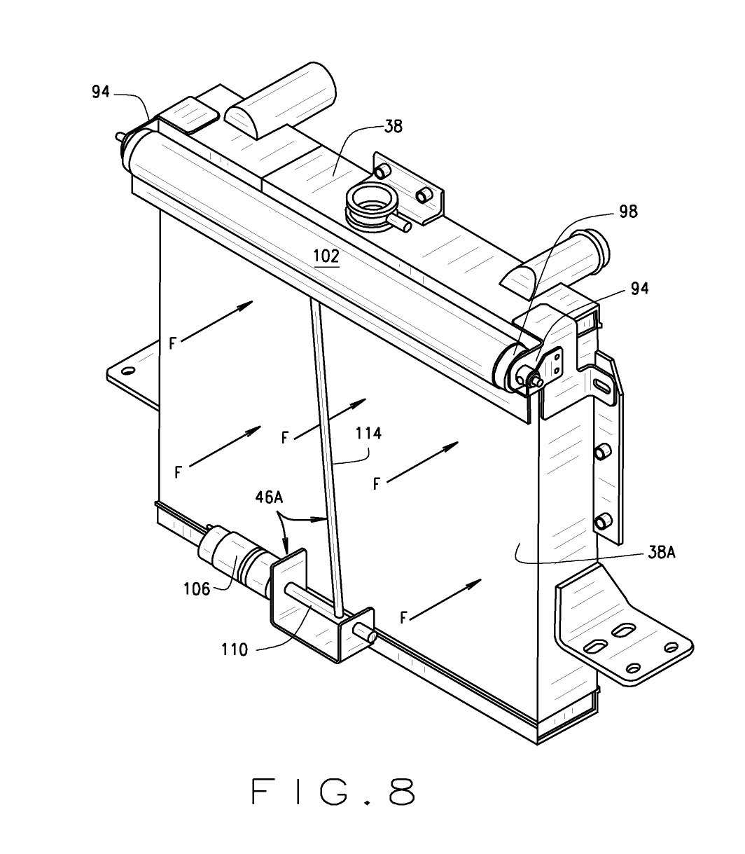

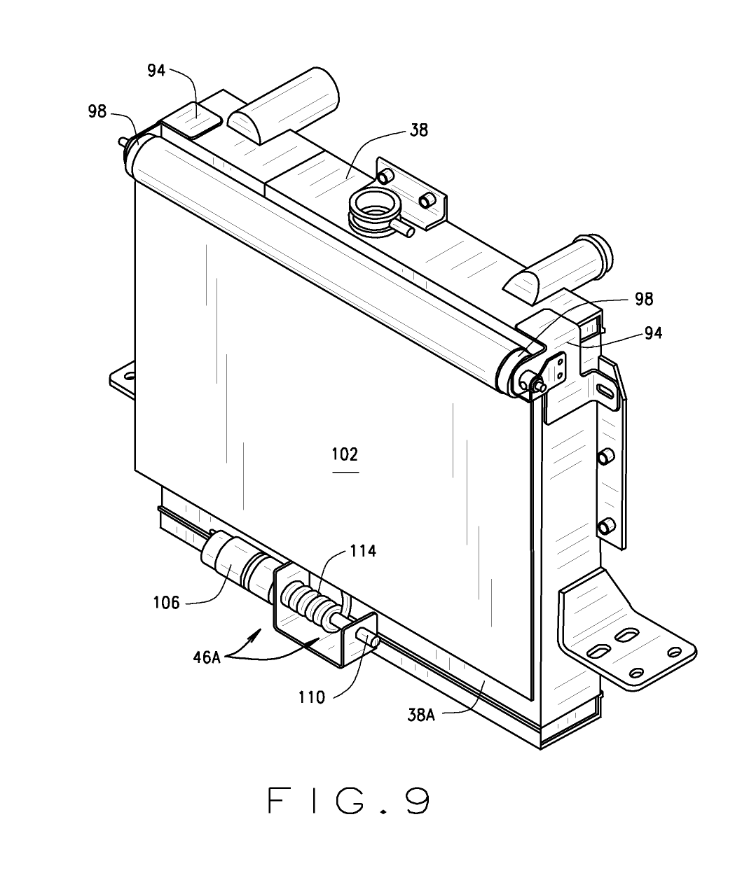

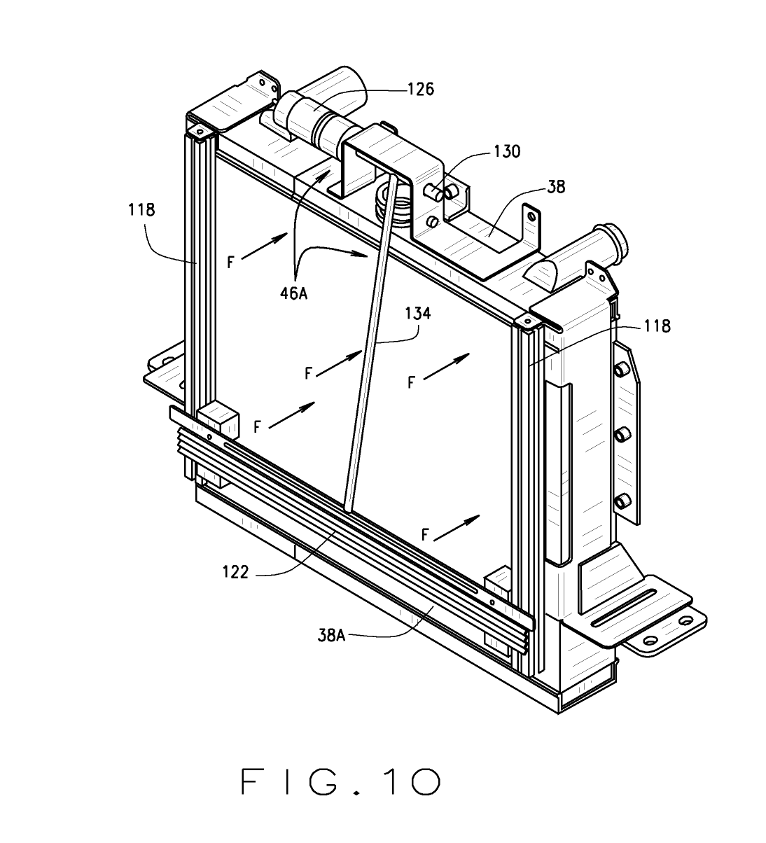

Referring now to FIGS. 8 and 9, in various embodiments, the airflow interruption device 42 comprises a roller baffle device that includes a head unit 94 mounted to the radiator 38, a biased retraction barrel 98 rotationally mounted within the head unit 97 and a flexible, roller baffle panel 102 connected to and disposable around the retraction barrel 98. Particularly, the retraction barrel 98 comprises an internal biasing device (not shown), such as a torsion spring, that rotationally biases the retraction barrel 98 about a longitudinal axis of the retraction barrel 98, and the roller baffle panel 102 is disposable, or windable, around the retraction barrel 98 in a manner similar to window roller shade. Hence, when the roller baffle panel 102 is in a retracted, or recoiled, state that corresponds to the Open position of the airflow interruption device 42 (as shown in FIG. 9), the roller baffle panel 102 is wound around the retraction barrel 98, via the torsional biasing force exerted by the biasing device on the barrel 98. Conversely, when the roller baffle panel 102 is in an extended state that corresponds to the Closed position of the airflow interruption device 42 (as shown in FIG. 10), the roller baffle panel 102 is unwound from the barrel 98 and extended over the radiator air intake face 38A, in close proximity (e.g., 0.10-0.25 inches) to the radiator air intake face 38A.

As controlled by the control system 46 (i.e., the actuator 46A and actuator controller 46B), the roller baffle panel 102 is selectively translatable between the Open position and the Closed position. Importantly, as illustrated in FIG. 8, when in the Open position, the roller baffle panel 102 is retracted, thereby exposing the radiator intake face 38A so the airflow F can pass. That is, when the roller baffle panel 102 is retracted to the Open position the radiator fan 40 can generate the airflow F that is drawn from the exterior environment through the air intake screen 14, past the retracted roller baffle panel 102, and through the radiator 38 to cool the engine coolant flowing therethrough and hence cool the engine 26.

Equally important, as illustrated in FIG. 9, when in the Closed position, the roller baffle panel 102 is extended and blocks the radiator intake face 38A such that the airflow F cannot be generated. Therefore, during the time interval that the air flow interruption device 42 is in the Closed position, e.g., when the roller baffle panel 102 is extended, the airflow F is blocked from flowing, and thereby ceased and no longer present to hold any debris on the air intake screen. Accordingly, the debris will fall to the ground via gravity and the vibration of the air intake screen 14 cause by operation of the vehicle 22, thereby clearing, or cleaning, the air intake screen 14 of such debris. Subsequently, the baffle panel 102 is allowed to retract and returned the Open position such that the airflow F can again be generated.

In such embodiments, the actuator 46A can comprise any device, mechanism or system suitable to selectively extend the roller baffle panel 102, and selectively allow the roller baffle panel 102 to be retracted, via the rotational force of the biasing device on the retraction barrel 98. For example, as exemplarily illustrated in FIGS. 8 and 9, in various embodiments the actuator 46A can comprise a motor 106 having a spool shaft 110 extending therefrom and a tether cord 114 (e.g., a cord, wire, cable, strap, etc.) connected at a first end to the spool shaft 110 and at an opposing second end to the roller baffle panel 102. The motor 106 is structured and operable, as controlled by the actuator controller 46B, to bidirectionally rotate the spool shaft 110 to translate the roller baffle panel 102 between the Closed and Open positions. Particularly, to extend the roller baffle panel 102, i.e., to translate the roller baffle panel 102 from the Open position to the Closed position, the actuator controller 46B controls operation of the motor 106 to turn the spool shaft 110 such that the tether cord 114 is wound, or spooled, around the spool shaft 110. Accordingly, due to the connection of the tether cord 114 to the roller baffle panel 102, the roller baffle panel 102 is unwound from the retraction barrel 98 and extended to cover the radiator air intake face 38A. Subsequently, to translate the roller baffle panel 102 from the Closed position to the Open position, the actuator controller 46B controls operation of the motor 106 to turn the spool shaft 110 such that the tether cord 114 is unwound, or unspooled, from around the spool shaft 110. Accordingly, due to torsional force of the biasing device on the retraction barrel 98, the retraction barrel 98 rotates to recoil the baffle panel 102, i.e., wind, or wrap, the roller baffle panel 102 around the retraction barrel 98, thereby uncovering the radiator air intake face 38A such that the airflow F can again be generated.

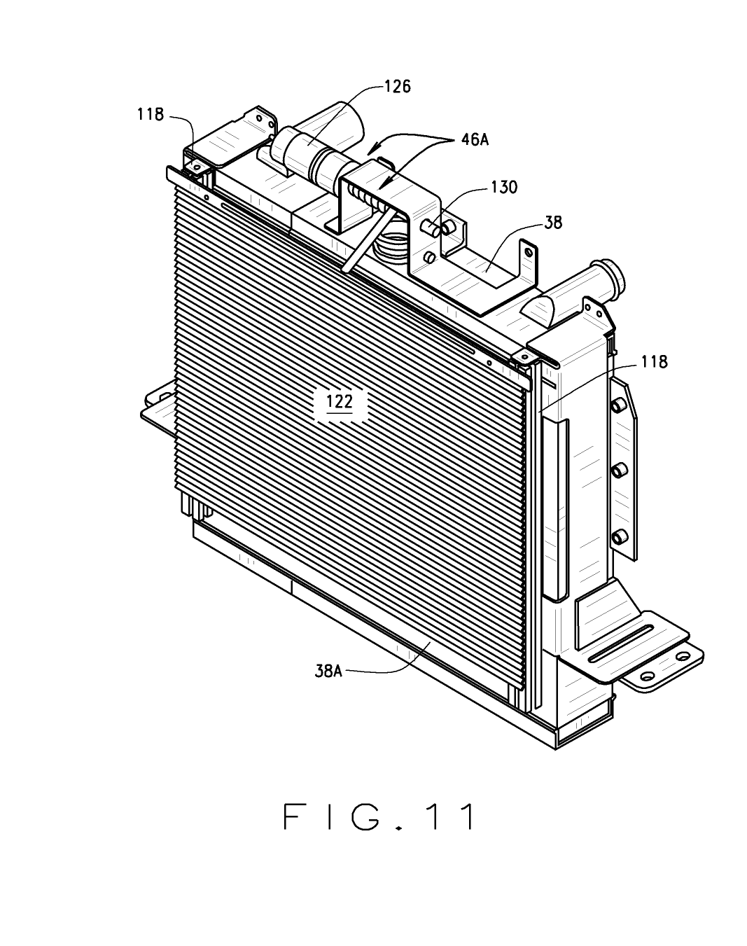

Referring now to FIGS. 10 and 11, in various embodiments, the airflow interruption device 42 comprises an accordion baffle device that includes a frame mounted to the radiator 38 and an accordion baffle panel 122 slideably disposed within, or connected to, the frame 118. The accordion baffle panel 122 is a flexible panel comprising a plurality of folds, or pleats, such that the accordion baffle panel 122 can be extended and collapsed in the same manner as an accordion. As illustrated in FIG. 10, when the accordion baffle panel 1 is in a collapsed state that corresponds to the Open position of the airflow interruption device 42, the accordion baffle panel 122 is folded, collapsed, compressed or stacked, adjacent a bottom portion of the radiator air intake face 38A, via gravitational force. Conversely, as illustrated in FIG. 11, when the accordion baffle panel 122 is in an extended state that corresponds to the Closed position of the airflow interruption device 42 the accordion baffle panel 122 is decompressed, unfolded, or unstacked, and extended over the radiator air intake face 38A, in close proximity (e.g., 0.10-0.25 inches) to the radiator air intake face 38A.

As controlled by the control system 46 (i.e., the actuator 46A and actuator controller 46B), the accordion baffle panel 122 is selectively translatable between the Open position and the Closed position. Importantly, as illustrated in FIG. 10, when in the Open position, the accordion baffle panel 122 is collapsed adjacent the bottom of the radiator air intake face 38A, thereby exposing the radiator intake face 38A so the airflow F can pass. That is, when the accordion baffle panel 122 is collapsed to the Open position the radiator fan 40 can generate the airflow F that is drawn from the exterior environment through the air intake screen 14, past the retracted accordion baffle panel 122, and through the radiator 38 to cool the engine coolant flowing therethrough and hence cool the engine 26.

Equally important, as illustrated in FIG. 11, when in the Closed position, the accordion baffle panel 122 is extended and blocks the radiator intake face 38A such that the airflow F cannot be generated. Therefore, during the time interval that the air flow interruption device 42 is in the Closed position, e.g., when the accordion baffle panel 122 is extended, the airflow F is blocked from flowing, and thereby ceased and no longer present to hold any debris on the air intake screen. Accordingly, the debris will fall to the ground via gravity and the vibration of the air intake screen 14 cause by operation of the vehicle 22, thereby clearing, or cleaning, the air intake screen 14 of such debris. Subsequently, the accordion baffle panel 122 is allowed to collapse and returned the Open position such that the airflow F can again be generated.

In such embodiments, the actuator 46A can comprise any device, mechanism or system suitable to selectively extend the accordion baffle panel 122, and selectively allow the baffle panel 102 to collapse, via gravitational force. For example, as exemplarily illustrated in FIGS. 10 and 11, in various embodiments the actuator 46A can comprise a motor 126 having a spool shaft 130 extending therefrom and a tether cord 134 (e.g., a cord, wire, cable, strap, etc.) connected at a first end to the spool shaft 130 and at an opposing second end to the accordion baffle panel 122. The motor 126 is structured and operable, as controlled by the actuator controller 46B, to bidirectionally rotate the spool shaft 130 to translate the accordion baffle panel 122 between the Closed and Open positions. Particularly, to extend the accordion baffle panel 122, i.e., to translate the accordion baffle panel 122 from the Open position to the Closed position, the actuator controller 46B controls operation of the motor 126 to turn the spool shaft 130 such that the tether cord 134 is wound, or spooled, around the spool shaft 130. Accordingly, due to the connection of the tether cord 134 to the accordion baffle panel 122, the accordion baffle panel 122 is decompressed, unfolded, or unstacked and extended to cover the radiator air intake face 38A. Subsequently, to translate the accordion baffle panel 102 from the Closed position to the Open position, the actuator controller 46B controls operation of the motor 126 to turn the spool shaft 130 such that the tether cord 134 is unwound, or unspooled, from around the spool shaft 130. Accordingly, due to gravitational force, the accordion baffle panel 102 compresses, folds up, or stacks, thereby uncovering the radiator air intake face 38A such that the airflow F can again be generated.

As used herein, the terms top, bottom, upper, lower, up and down are used in reference to the orientation and disposition of the radiator 38 and accordion baffle panel 102 as presented in FIGS. 10 and 11.

It should be noted that the airflow interruption device 42, as described above in the various exemplary embodiments, and no component, part, device, mechanism or assembly thereof are powered by the engine 26 are any component of the engine 26.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A system for removing debris collected on a radiator air intake screen of a turf-care vehicle hood, said system comprising:
an airflow interruption device mountable to a radiator of a turf-care vehicle under a hood of the vehicle, the airflow interruption device structured and operable to be selectively translatable between an Open position and a Closed position to selectively interrupt an airflow flowing through an air intake screen of the hood into the radiator; and
a control system comprising an actuator and an actuator controller, the control system structured and operable to selectively translate the airflow interruption device between the Open and Closed positions.

2. The system of claim 1, wherein the airflow interruption device comprises a polarizing panel device comprising:
a first vented panel having a plurality of first vent apertures formed therein and a plurality of first baffles formed between the first vent apertures, and
a second vented panel having a plurality of second vent apertures formed therein and a plurality of second baffles formed between the second vent apertures, the second vent apertures and baffles respectively having substantially the same shape and size as the first vent apertures and baffles, wherein
the second vented panel is movable relative to the first vented panel, via the control system, such that the polarizing panel device can be selectively translated between:
the Open position wherein the first and second vent apertures align such that the airflow is allowed to flow through the air intake screen of the hood into the radiator, and
the Closed position wherein the first baffles align with the second vent apertures and the second baffles align with the first vent apertures, such that the airflow is interrupted from flowing through the air intake screen of the hood into the radiator.

3. The system of claim 1, wherein the airflow interruption device comprises a louver panel device comprising a frame and a plurality of louver slats pivotally mounted within the frame, wherein the louver slats are pivotal within the frame, via the control system, such that the louver panel device can be selectively translated between:
the Open position wherein the louvers are pivoted to provide open space between adjacent louvers such that the airflow is allowed to flow through the air intake screen of the hood into the radiator, and
the Closed position wherein the louvers are pivoted such that each louver overlaps with the adjacent louvers such that the airflow is interrupted from flowing through the air intake screen of the hood into the radiator.

4. The system of claim 1, wherein the airflow interruption device comprises a roller baffle device comprising a head unit, a biased barrel rotationally mounted within the head unit and a flexible baffle panel connected to and disposable around the barrel, wherein the baffle panel is selectively translatable, via the control system, between:
the Open position wherein the flexibly baffle panel is wrapped around the barrel such that the airflow is allowed to flow through the air intake screen of the hood into the radiator, and
the Closed position wherein the flexible baffle panel is unwrapped from the barrel such that the flexible baffle panel covers an air intake face of the radiator such that the airflow is interrupted from flowing through the air intake screen of the hood into the radiator.

5. The system of claim 1, wherein the airflow interruption device comprises an accordion baffle device comprising a frame and an accordion baffle panel slideably connected to the frame, wherein the accordion panel is selectively translatable, via the control system, between:
the Open position wherein the accordion baffle panel is collapsed such that the airflow is allowed to flow through the air intake screen of the hood into the radiator, and
the Closed position wherein the accordion baffle panel is extended such that the accordion baffle panel covers an air intake face of the radiator such that the airflow is interrupted from flowing through the air intake screen of the hood into the radiator.

6. A turf-care vehicle, said vehicle comprising;
a debris removal system for removing debris collected on a radiator air intake screen of a hood of the turf-care vehicle, wherein said debris removal system comprises:
an airflow interruption device mountable to a radiator of a turf-care vehicle under a hood of the vehicle, the airflow interruption device structured and operable to be selectively translatable between an Open position and a Closed position to selectively interrupt an airflow flowing through an air intake screen of the hood into the radiator; and
a control system comprising an actuator and an actuator controller, the control system structured and operable to selectively translate the airflow interruption device between the Open and Closed positions.

7. The vehicle of claim 6, wherein the airflow interruption device comprises a polarizing panel device comprising:
a first vented panel having a plurality of first vent apertures formed therein and a plurality of first baffles formed between the first vent apertures, and
a second vented panel having a plurality of second vent apertures formed therein and a plurality of second baffles formed between the second vent apertures, the second vent apertures and baffles respectively having substantially the same shape and size as the first vent apertures and baffles, wherein
the second vented panel is movable relative to the first vented panel, via the control system, such that the polarizing panel device can be selectively translated between:
the Open position wherein the first and second vent apertures align such that the airflow is allowed to flow through the air intake screen of the hood into the radiator, and
the Closed position wherein the first baffles align with the second vent apertures and the second baffles align with the first vent apertures, such that the airflow is interrupted from flowing through the air intake screen of the hood into the radiator.

8. The vehicle of claim 6, wherein the airflow interruption device comprises a louver panel device comprising a frame and a plurality of louver slats pivotally mounted within the frame, wherein the louver slats are pivotal within the frame, via the control system, such that such that the louver panel device can be selectively translated between:
the Open position wherein the louvers are pivoted to provide open space between adjacent louvers such that the airflow is allowed to flow through the air intake screen of the hood into the radiator, and
the Closed position wherein the louvers are pivoted such that each louver overlaps with the adjacent louvers such that the airflow is interrupted from flowing through the air intake screen of the hood into the radiator.

9. The vehicle of claim 6, wherein the airflow interruption device comprises a roller baffle device comprising a head unit, a biased barrel rotationally mounted within the head unit and a flexible baffle panel connected to and disposable around the barrel, wherein the baffle panel is selectively translatable, via the control system, between:
the Open position wherein the flexibly baffle panel is wrapped around the barrel such that the airflow is allowed to flow through the air intake screen of the hood into the radiator, and
the Closed position wherein the flexible baffle panel is unwrapped from the barrel such that the flexible baffle panel covers an air intake face of the radiator such that the airflow is interrupted from flowing through the air intake screen of the hood into the radiator.

10. The vehicle of claim 6, wherein the airflow interruption device comprises an accordion baffle device comprising a frame and an accordion baffle panel slideably connected to the frame, wherein the accordion panel is selectively translatable, via the control system, between:
the Open position wherein the accordion baffle panel is collapsed such that the airflow is allowed to flow through the air intake screen of the hood into the radiator, and
the Closed position wherein the accordion baffle panel is extended such that the accordion baffle panel covers an air intake face of the radiator such that the airflow is interrupted from flowing through the air intake screen of the hood into the radiator.

11. A method for removing debris collected on a radiator air intake screen of a turf-care vehicle hood, said method comprising:
selectively translating an airflow interruption device mountable to a radiator of a turf-care vehicle between an Open position and a Closed position;
temporarily interrupting, as result of translating the airflow interruption device between the Open and Closed positions, a flow of air through an air intake screen of a turf-care vehicle hood into the radiator of the vehicle such that debris is no longer retained against the air intake screen by the flow of air; and
operating the turf-care vehicle to vibrate the air intake screen such the debris is dislodged from the air intake screen.

12. The method of claim 11, wherein the airflow interruption device comprises a polarizing panel device comprising a first vented panel having a plurality of first vent apertures formed therein and a plurality of first baffles formed between the first vent apertures, and a second vented panel having a plurality of second vent apertures formed therein and a plurality of second baffles formed between the second vent apertures, the second vent apertures and baffles respectively having substantially the same shape and size as the first vent apertures and baffles, and wherein selectively translating the airflow interruption device between the Open and Closed positions comprises moving the second vented panel relative to the first vented panel, such that the polarizing panel device is selectively translated between:
the Open position wherein the first and second vent apertures align such that the airflow is allowed to flow through the air intake screen of the hood into the radiator, and
the Closed position wherein the first baffles align with the second vent apertures and the second baffles align with the first vent apertures, such that the airflow is interrupted from flowing through the air intake screen of the hood into the radiator.

13. The method of claim 11, wherein the airflow interruption device comprises a louver panel device comprising a frame and a plurality of louver slats pivotally mounted within the frame, wherein the louver slats are pivotal within the frame, and wherein selectively translating the airflow interruption device between the Open and Closed positions comprises selectively pivoting the louvers between:
the Open position wherein the louvers are pivoted to provide open space between adjacent louvers such that the airflow is allowed to flow through the air intake screen of the hood into the radiator, and
the Closed position wherein the louvers are pivoted such that each louver overlaps with the adjacent louvers such that the airflow is interrupted from flowing through the air intake screen of the hood into the radiator.

14. The method of claim 11, wherein the airflow interruption device comprises a roller baffle device comprising a head unit, a biased barrel rotationally mounted within the head unit and a flexible baffle panel connected to and disposable around the barrel, and wherein selectively translating the airflow interruption device between the Open and Closed positions comprises selectively translating the baffle panel between:
the Open position wherein the flexibly baffle panel is wrapped around the barrel such that the airflow is allowed to flow through the air intake screen of the hood into the radiator, and
the Closed position wherein the flexible baffle panel is unwrapped from the barrel such that the flexible baffle panel covers an air intake face of the radiator such that the airflow is interrupted from flowing through the air intake screen of the hood into the radiator.

15. The method of claim 11, wherein the airflow interruption device comprises an accordion baffle device comprising a frame and an accordion baffle panel slideably connected to the frame, and wherein selectively translating the airflow interruption device between the Open and Closed positions comprises selectively translating the accordion panel between:
the Open position wherein the accordion baffle panel is collapsed such that the airflow is allowed to flow through the air intake screen of the hood into the radiator, and
the Closed position wherein the accordion baffle panel is extended such that the accordion baffle panel covers an air intake face of the radiator such that the airflow is interrupted from flowing through the air intake screen of the hood into the radiator.
